(19) United States
(12) Patent Application Publication
(10) Pub. No.: US 2012/0044260 A1
(43) Pub. Date: Feb. 23, 2012

(54) Image Processing Device, Method, and Program

(76) Inventor: Jun HIRAI, Tokyo (JP)

(21) Appl. No.: 13/196,378

(22) Filed: Aug. 2, 2011

(30) Foreign Application Priority Data
Aug. 18, 2010 (JP) P2010-183179

(51) Int. Cl. G09G 5/00

(52) U.S. Cl. 345/629

(57) ABSTRACT

A processing device may include left-eye and right-eye content data processing units, which may be configured to, respectively, receive left-eye content data representing a left-eye content display pattern and right-eye content data representing a right-eye content display pattern. The content data processing units may also be configured to, respectively, set content display positions of the left-eye and right-eye content display patterns. The settings may be based, respectively, on positions of virtual screen display patterns included in background display patterns represented by left-eye and right-eye background data. The device may also include an output unit, which may be configured to crate output data by, respectively, combining the left-eye content data with the left-eye background data and combining the right-eye content data with the right-eye background data. The combinings may be based on, respectively, the left-eye and right-eye content display positions. The output data may represent left-eye and right-eye output display patterns.

### CROSS-REFERENCE TO RELATED APPLICATION

This application claims priority of Japanese Patent Application No. 2010-183179, filed on Aug. 18, 2010, the entire content of which is hereby incorporated by reference.

### BACKGROUND

The present disclosure relates to an image processing device, method, and program, and more particularly relates to an image processing device, method, and program whereby, when displaying a small-size image on a large screen, the image can be displayed more effectively without deterioration in image quality.

When viewing an image recorded with an analog-age video camera on a large-screen HDTV (High Definition Television) in an enlarged manner for example, the outline of subjects may be too heavy, and the head switchover portions and hand blurring may be unsightly. However, in the event that an image smaller in size than the display screen is displayed without any change, no deterioration image quality occurs and image with high resolution can be viewed, but the black band around the image becomes large, and the viewer will wonder why the image is not viewable on the entire screen.

Now, as for a technique relating to display of images, there is proposed a technique wherein a picture-in-picture function is realized when playing contents in an optical disc (e.g., see Japanese Unexamined Patent Application Publication No. 2005-123775).

### SUMMARY

However, with the above related art, an image of a small size could not be displayed on a screen larger than the image, with no deterioration in image quality, and in an effective manner. For example, with the art realizing picture-in-picture functions, two contents are just played in parallel, so it could not be said that the image is being displayed effectively. Also, of the contents played in parallel, in the event that the size of the image of the content to be displayed larger is smaller than the display screen, that image has to be displayed enlarged, so image quality deteriorates.

It has been found to be desirable to enable, when displaying a small-size image on a large screen, the image to be displayed more effectively without deterioration in image quality.

Accordingly, there is disclosed a processing device for combining content data with background data. The device may include a left-eye content data processing unit, which may be configured to receive left-eye content data representing a left-eye content display pattern. The left-eye content data processing unit may also be configured to set a left-eye content display position of the left-eye content display pattern, based on a position of a left-eye virtual screen display pattern included in a left-eye background display pattern represented by left-eye background data. The device may also include a right-eye content data processing unit, which may be configured to receive right-eye content data representing a right-eye content display pattern. The right-eye content data processing unit may also be configured to set a right-eye content display position of the right-eye content display pattern, based on a position of a right eye virtual screen display pattern included in a right-eye background display pattern represented by right-eye background data. In addition, the device may include an output unit, which may be configured to combine the left-eye content data with the left-eye background data to create left-eye output data representing a left-eye output display pattern, based on the left-eye content display position. The output unit may also be configured to combine the right-eye content data with the right-eye background data to create right-eye output data representing a right-eye output display pattern, based on the right-eye content display position.

There is also disclosed a method of combining content data with background data. A processor may execute a program to cause a processing device to perform the method. The program may be stored on a non-transitory, computer-readable storage medium. The method may include receiving left-eye content data representing a left-eye content display pattern. The method may also include setting a left-eye content display position of the left-eye content display pattern, based on a position of a left-eye virtual screen display pattern included in a left-eye background display pattern represented by left-eye background data. Additionally, the method may include receiving right-eye content data representing a right-eye content display pattern. The method may also include setting a right-eye content display position of the right-eye content display pattern, based on a position of a right eye virtual screen display pattern included in a right-eye background display pattern represented by right-eye background data. The method may also include combining the left-eye content data with the left-eye background data to create left-eye output data representing a left-eye output display pattern, based on the left-eye content display position. In addition, the method may include combining the right-eye content data with the right-eye background data to create right-eye output data representing a right-eye output display pattern, based on the right-eye content display position.

According to the above-described configurations, when displaying a small-size image on a large screen, the image can be displayed more effectively without deterioration in image quality.

### BRIEF DESCRIPTION OF THE DRAWINGS

FIG. 1 is a diagram illustrating a configuration example of an embodiment of an image processing device to which the present disclosure has been applied;

FIG. 2 is a diagram illustrating an example of a background image;

FIG. 3 is a flowchart for describing background image generating processing;

FIG. 4 is a flowchart for describing content playing processing;

FIG. 5 is a diagram illustrating another configuration example of an image processing device;

FIG. 6 is a flowchart for describing content playing processing;

FIG. 7 is a diagram illustrating an external configuration example of an image processing device;

FIG. 8 is a diagram illustrating a functional configuration example of an image processing device;

FIG. 9 is a flowchart for describing content playing processing; and

FIG. 10 is a block diagram illustrating a configuration example of a computer.

### DETAILED DESCRIPTION OF EMBODIMENTS

Embodiments to which the present disclosure has been applied will be described with reference to the drawings.

### First Embodiment

### Configuration of Image Processing Device

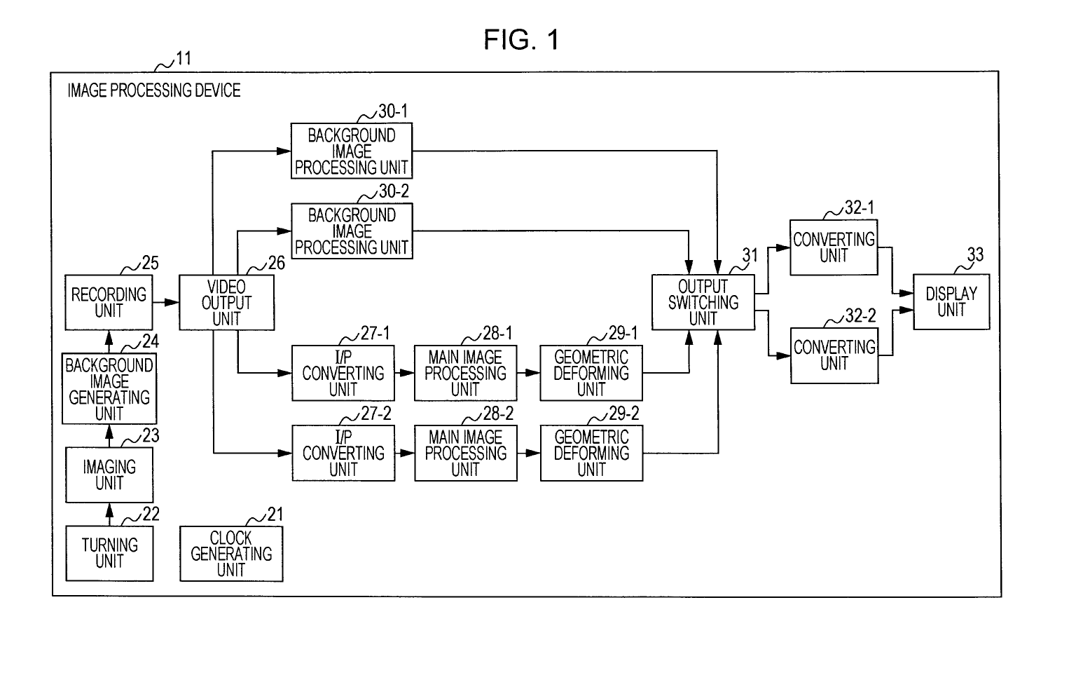

FIG. 1 is a diagram illustrating a configuration example of an embodiment of an image processing device to which the present disclosure has been applied. An image processing device 11 is configured of a clock generating unit (i.e., a software module, a hardware module, or a combination of a software module and a hardware module) 21, a turning unit 22, an imaging unit 23, a background image generating unit 24, a recording unit 25, a video output unit 26 (i.e., an original content data processing unit), an I/P (Interlace/Progressive) converting unit 27-1 (i.e., a content data conversion unit), an I/P converting unit 27-2 (i.e., a content data conversion unit), a main image processing unit 28-1 (i.e., a left-eye content data processing unit), a main image processing unit 28-2 (i.e., a right-eye content data processing unit), a geometric deforming unit 29-1 (i.e., a content data deformation unit), a geometric deforming unit 29-2 (i.e., a content data deformation unit), a background image processing unit 30-1 (i.e., a background data processing unit), a background image processing unit 30-2 (i.e., a background data processing unit), an output switching unit 31 (i.e., an output unit) , a converting unit 32-1 (i.e., an output data conversion unit), a converting unit 32-2 (i.e., an output data conversion unit), and a display unit 33.

The image processing device 11 displays an image of a content such as SDTV (Standard Definition Television) (hereinafter referred to as “main image” (i.e., a left-eye and/or right-eye content display pattern) or the like on a display screen of an HDTV size for example, and further displays an image serving as a background surrounding this main image (hereinafter referred to as “background image” (i.e., a left-eye and/or right eye background display pattern).

The clock generating unit 21 generates a clock serving as a reference for the operation timing for the entire image processing device 11, and supplies this to each part of the image processing device 11. The parts of the image processing device 11 operate synchronously with the clock supplied from the clock generating unit 21.

The turning unit 22 holds the imaging unit 23 and also turns the imaging unit 23 in a predetermined direction with the center of a light receiving face of an imaging device of the imaging unit 23 as the center of rotation. The imaging unit 23 receives light input from a subject and performs photoelectric conversion thereof, thereby imaging an image of the subject. For example, in the event that a background image is to be generated, the imaging unit 23 images a theater or the like to be displayed in the background image as the subject.

The background image generating unit 24 generates a background image based on multiple images supplied from the imaging unit 23, and supplies this to the recording unit 25. Now, the background image is an image whereby a sense of unity with the main image can be obtained when composited and displayed with the main image, such as a theater to which a screen has been provided, a room such as a living room or the like where a television receiver or screen has been provided, for example.

Also, the size of the background image, i.e., the number of pixels making up the background image, is the same as the size (the number of pixels making up the display screen) of the display screen of the display unit 33 for example, and the background image is made up of a background image for the left eye and a background image for the right eye, so as to display a stereoscopic image. Now, an image for the left eye is an image presented to the user to be observed with the left eye thereof, and an image for the right eye is an image presented to the user to be observed with the right eye thereof, for when performing stereoscopic display of the image.

The recording unit 25 stores multiple background images supplied from the background image generating unit 24 and main images externally acquired, and supplies main images and background images to the video output unit 26 in accordance with user instructions.

The video output unit 26 switches the output destination of the image in accordance with the usage of the images supplied from the recording unit 25. For example, in the event that the main image is a stereoscopic image, the video output unit 26 supplies the main image for the left eye and the main image for the right eye to the I/P converting unit 27-1 and I/P converting unit 27-2, respectively. In the event that the main image is a two-dimensional image which is not for stereoscopic display, the video output unit 26 supplies the same main image to the I/P converting unit 27-1 and I/P converting unit 27-2 as the main image for the left eye and for the right eye. Further, the video output unit 26 supplies a background image for the left eye and a background image for the right eye to the background image processing unit 30-1 and background image processing unit 30-2, respectively.

The I/P converting unit 27-1 and I/P converting unit 27-2 perform I/P conversion as appropriate on the main image supplied from the video output unit 26, and supply this to the main image processing unit 28-1 and main image processing unit 28-2. Due to this I/P conversion, the main image is converted (i.e., reformatted) from an interlaced format image to a progressive format image. Note that in the event that the main image has been obtained with a progressive scan, the processing of this I/P conversion will be skipped.

The main image processing unit 28-1 and main image processing unit 28-2 subject the main image supplied from the I/P converting unit 27-1 and I/P converting unit 27-2 to various types of image processing and color matrix conversion for adjusting the contrast, brightness, and so forth, and supplies this to the geometric deforming unit 29-1 and geometric deforming unit 29-2. The geometric deforming unit 29-1 and geometric deforming unit 29-2 perform geometric deforming on the main image supplied from the main image processing unit 28-1 and main image processing unit 28-2, and supply to the output switching unit 31.

Note that hereinafter, in the event that the I/P converting unit 27-1 and I/P converting unit 27-2 do not have to be individually differentiated, these will also be referred to simply as I/P converting unit 27, and in the event that the main image processing unit 28-1 and main image processing unit 28-2 do not have to be individually differentiated, these will also be referred to simply as main image processing unit 28. Also, hereinafter, in the event that the geometric deforming unit 29-1 and geometric deforming unit 29-2 do not have to be individually differentiated, these will also be referred to simply as geometric deforming unit 29.

The background image processing unit 30-1 and background image processing unit 30-2 perform image processing such as luminance adjustment on the background images for the left eye and for the right eye, supplied from the video output unit 26, and supply to the output switching unit 31. Note that hereinafter, in the event that the background image processing unit 30-1 and background image processing unit 30-2 do not have to be individually differentiated, these will also be referred to simply as background image processing unit 30.

The output switching unit 31 supplies one or the other of the main image from the geometric deforming unit 29 and the background image from the background image processing unit 30 to the converting unit 32-1 or the converting unit 32-2. For example, in the event of displaying an image (i.e., a left-eye and/or right-eye output display pattern) on the display screen of the display unit 33, the output switching unit 31 selects pixels making up the display screen in raster scan order, and outputs the data of the pixels of the image to be displayed (i.e., left-eye and/or right-eye output data) at the selected pixels, to the converting unit 32-1 or converting unit 32-2. Accordingly, if the main image is to be displayed at the selected pixels for example, the data of the pixels of the main image (i.e., left-eye and/or right-eye content data) corresponding to these pixels is output to the converting unit 32-1 or converting unit 32-2, and in the event that the background image is to be displayed at the selected pixels, the data of the pixels of the background image (i.e., left-eye and/or right-eye background data) corresponding to these pixels is output to the converting unit 32-1 or converting unit 32-2. Particularly, an image for the left eye is supplied to the converting unit 32-1, and an image for the right eye is supplied to the converting unit 32-2.

The converting unit 32-1 and converting unit 32-2 convert the color system of the image supplied from the output switching unit 31, and supply to the display unit 33. Specifically, with the converting unit 32-1 and converting unit 32-2, the color system of the image is converted from YCbCr (4:2:2) to YCbCr (4:4:4). Note that hereinafter, in the event that the converting unit 32-1 and converting unit 32-2 do not have to be individually differentiated, these will also be referred to simply as converting unit 32.

The display unit 33 performs stereoscopic display of the image supplied from the converting unit 32. Note that the format of stereoscopic display of the image at the display unit 33 may be any format, such as lenticular format, field-sequential shutter format, or the like.

### Description of Display Mode

Now, in the event of displaying an image of the display unit 33, the image processing device 11 is arranged such that one of a theater background mode or enlarged size mode can be selected as the display mode. The theater background mode is a mode wherein the background image and main image are composited and the one image obtained by compositing is displayed. Also, the enlarged size mode is a mode wherein the image is enlarged to match the display screen of the display unit 33 as appropriate, and displayed.

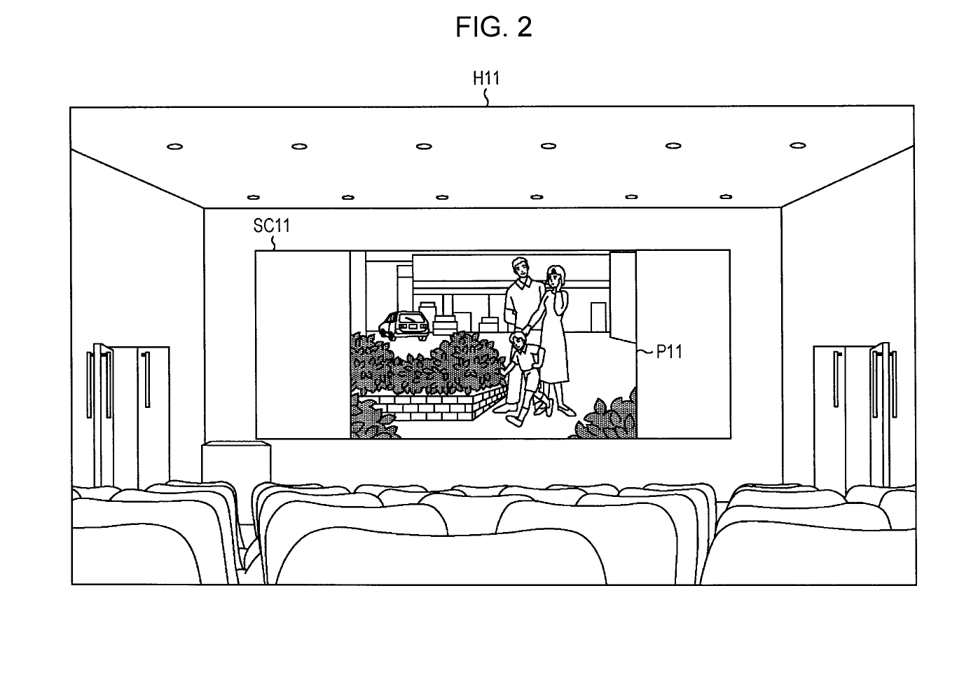

For example, in the event that the main image is to be displayed in the theater background mode, as shown in FIG. 2, a background image of a theater to which a screen SC11 has been provided is displayed on the entire display screen H11 of the display unit 33, and the main image P11 is displayed at the middle portion of the screen SC11. In the theater background mode, the background image prepared beforehand and the main image P11 are effectively displayed with a sense of unity, whereby the user viewing the main image P11 can feel as if the contents were being viewed in a theater.

In the example in FIG. 2, the main image P11 is an image of the size of SDTV wherein the number of pixels in the vertical direction and horizontal direction is smaller than the number of pixels in the vertical direction and horizontal direction making up the display screen H11 in the drawing, and the main image P11 is displayed at the original size, being neither enlarged nor reduced. Also, the main image P11 is displayed in the middle of the display screen H11, with the background image having the screen SC11 situated at the position of the same height as with the main image P11.

In the background image, the screen SC11 (i.e., a left-eye and/or right-eye virtual screen display pattern) is situated at the middle, and a door for entering and exiting the theater is provided near the screen SC11. Also, multiple seats are provided in the background image closer in the drawing, and lights for illuminating within the theater are provided on the ceiling at the top in the drawing.

Such a background image is rendered such that the main image P11 appears larger. For example, when stereoscopic display of the background image is performed at the display unit 33, the disparity of the screen SC11 increases, and the disparity of seats which are closer in the drawing is smaller, thereby expressing the depth of the background image.

Also, arrangements are made such that the screen SC11 where the main image P11 is displayed is sensed by the user to be situated at the far side, by various effects such as the seats which are closer being shown larger, and sense of depth such as the arrises of the walls of the theater heading toward the center of the display screen H11 and so forth.

The human brain has a habit of calculating that distant objects should actually be large even if they are projected small on the retinas. Accordingly, the user can be made to feel that the main image P11 is being displayed large by expressing a sense of depth so as to make the user to sense that the screen SC11 in the background image is at the far side.

Particularly, by situating objects which humans can mentally recognize the size, such as people, seats, doors, and so forth, i.e., objects which the user is familiar with, near the screen SC11 in the background image, the user can be made to easily recognize that the screen SC11 is at the far side in the drawing. Further, the human brain estimates the size of the screen SC11 near the objects with the objects of which the user is familiar with the size, as a reference, so displaying the objects which the user is familiar with in a small size allows the screen SC11 to be made to appear larger.

Also, the human eye sees objects that are closer than the objects which are being focused on in a blurred manner. While viewing the main image P11, the user should be focusing on the screen SC11 where the main image P11 is displayed, so the user can be made to feel further sense of depth by displaying the seats in a blurred manner such that the closer the seats are, the more blurred they appear.

Note that while description will continue with the background image being an image within a theater where a screen is provided, the background image is not restricted to this example, and may be an image of any venue where a place on which the main image is to be displayed is disposed.

### Description of Background Image Generating Processing

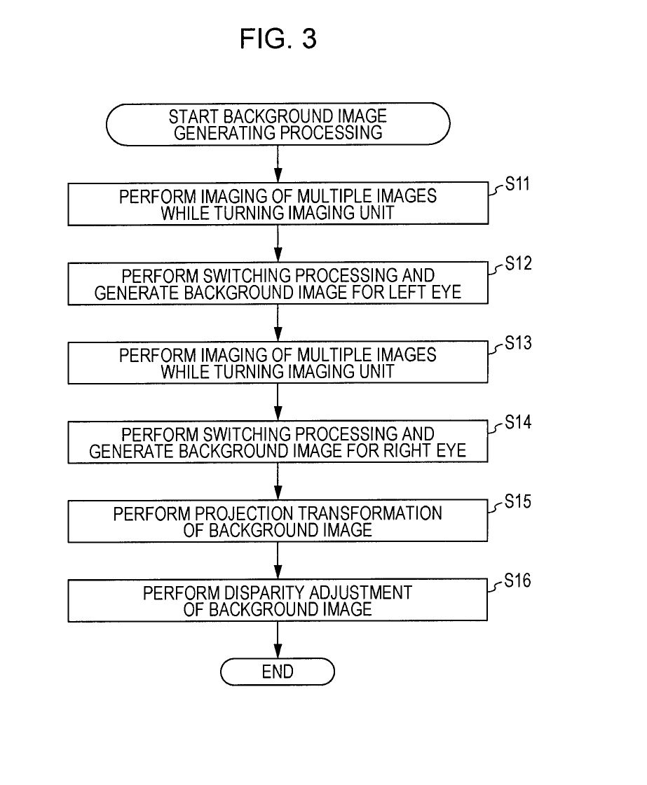

Next, the operations of the image processing device 11 will be described. For example, upon the image processing device 11 being set in a theater or the like to serve as a subject of the background image, and generating of a background image being instructed by user operations, the image processing device 11 performs background image generating processing to generate a background image. The background image generating processing performed by the image processing device 11 will now be described with reference to the flowchart in FIG. 3.

In step S11, the imaging unit 23 performs imaging multiple times with the theater or the like as the subject, for example, including overlapping portions while changing the angle of imaging, and supplies the images obtained by imaging to the background image generating unit 24. That is to say, the turning unit 22 turns the imaging unit 23 in a predetermined direction with the center of the light receiving face of the imaging device of the imaging unit 23 as the center of rotation. The imaging unit 23 temporally consecutively images multiple images while being turned by the turning unit 22. Accordingly, the same subjects will be included in duplicate in several of the images imaged consecutively.

In step S12, the background image generating unit 24 performs stitching processing using the multiple image supplied from the imaging unit 23 to generate a background image for the left eye.

That is to say, the background image generating unit 24 arrays the images on a virtual plane such that the portions of the same subject in the multiple images from the imaging unit 23 are overlaid. The background image generating unit 24 then cuts out a portion of each image as strip-shaped images, based on a reference position serving as a preset reference on each image. For example, a certain image region from a reference position in a certain image on the plane to the same position as the reference position in another image arrayed adjacent to that certain image is cut out as a strip-shaped image. In the state that the strip-shaped images cut out from each of the images are arrayed on a plane, the background image generating unit 24 synthesizes these strip-shaped images into one image, thereby generating a background image for the let eye.

Upon obtaining the background image for the left eye in this way, the turning unit 22 moves the imaging unit 23 in parallel in a predetermined direction by a distance corresponding to a predetermined disparity, such that the background image for the left eye and background image for the right eye have the predetermined disparity.

Subsequently, the processing of step S13 and step S14 is performed to generated the background image for the right eye, but these processing are processing the same as with step S11 and step S12, so description thereof will be omitted. That is to say, multiple images are imaged from a different perspective as to the time of generating the background image for the left eye, and a background image for the right eye is generated by stitching processing using the imaged images.

In step S15, the background image generating unit 24 performs projection transformation of the background images for the right eye and left eye that have been generated. More specifically, in the event that a background image such as shown in FIG. 2 is obtained for example, the background image generating unit 24 detects the four vertices of the square screen SC11 from the background image, and performs projection transformation of the background image such that a square connecting the vertices is rectangular in shape. Thus, projection of the screen SC11 is performed so as to be parallel to the display face of the display unit 33.

In step S16, the background image generating unit 24 performs disparity adjustment of the background images for the right eye and for the left eye.

For example, the background image generating unit 24 enlarges or reduces the background images for the left and right eyes, or shifts (parallel movement) the background images, so that the screen SC11 will be the same size and same position in the background images for the left and right eyes. In the event of performing stereoscopic display of the background images in this state, the screen SC11 is localized at the position of the display screen of the display unit 33, and the seats closer the user from the screen SC11 appear to be closer than the display screen of the display unit 33 from the user observing the display unit 33.

The background image generating unit 24 then shifts the background images for the left and right eyes such that the backrest of the closest seat in FIG. 2 is localized at the position of the display screen of the display unit 33, and the screen SC11 is localized farther away from the display screen of the display unit 33 as seen from the user, and disparity of the background images is adjusted. Upon a final background image being obtained by disparity adjustment, the background image generating unit 24 supplies the obtained background images for the left and right eyes to the recording unit 25 to be recorded, and the background image generating processing ends.

Note that multiple and different positions and sizes of the screen SC11 are prepared for the background image to match the size of the main image. Also, an arrangement may be made wherein multiple background images with different subjects are prepared. Thus, the image processing device 11 images multiple images in a state of turning, and generates background images by synthesizing the obtained images by stitching processing.

Thus, by generating background images by stitching processing, images with higher resolution can be used as background images. For example, in the case of using a theater as the subject for a background image, the diaphragm of the imaging unit 23 should be opened wide for imaging since inside theaters is dark. Accordingly, using one image obtained by imaging inside the theater as a background image results in a subject that is blurred and has low resolution. On the other hand, performing stitching processing of multiple images to be used as one image allows a background image with higher resolution to be obtained.

### Description of Content Playing Processing

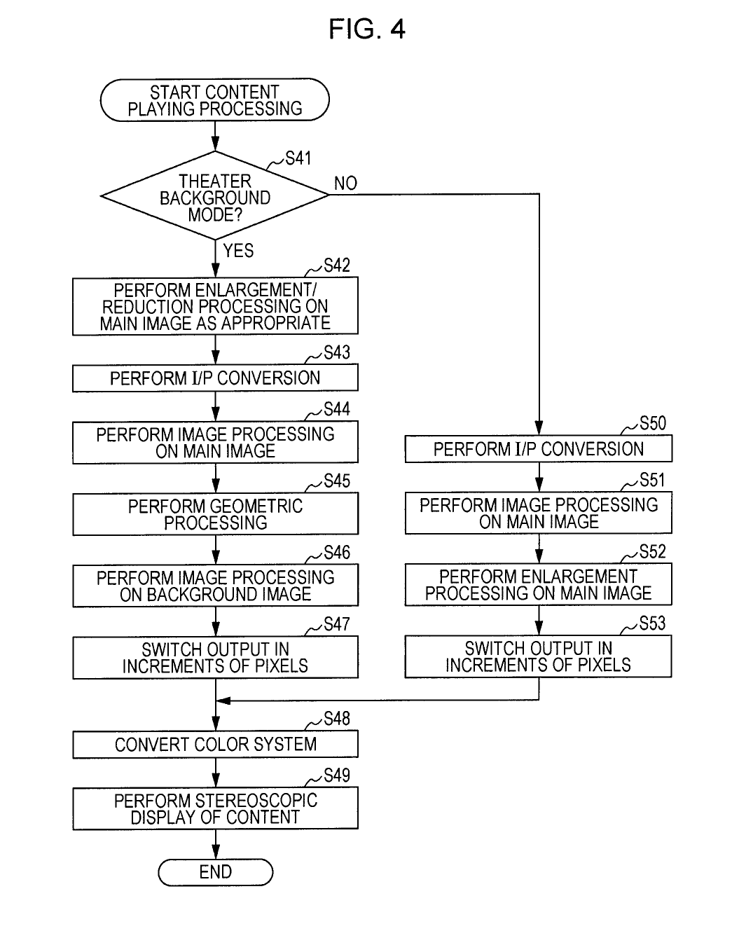

Also, upon the user operating the image processing device 11 to instruct playing of the main image which is the content, the image processing device 11 performs content playing processing and plays the instructed main image. The content playing processing according to the image processing device 11 will now be described with reference to the flowchart in FIG. 4.

In step S41, the video output unit 26 determines whether or not the theater background mode is selected as the display mode.

In step S41, in the event that determination is made that the theater background mode as the display mode, the video output unit 26 reads out the specified main image (i.e., original content data representing an original content display pattern including left-eye and/or right-eye original content display patterns) and background image from the recording unit 25, and the processing advances to step S42.

In step S42, the video output unit 26 performs enlarging/reduction processing on the main image read out from the recording unit 25, as appropriate.

For example, in the event that the main image is so-called Internet content or the like, and is smaller than a VGA (Video Graphics Array) image, the video output unit 26 performs enlargement of the main image so that the main image is a size stipulated by VGA. In the event that the main image is an SDTV image or 720p image, the main image is neither enlarged nor reduced.

Also, in the event that the main image is a 1080i image or 1080p image, the main image is reduced to the size of a 720p image. At this time, in the event that there is a black band (black screen) (i.e., a black band display pattern) in the main image, the video output unit 26 removes the black band from the main image, and further, in the event that there is caption (i.e., a caption display pattern) in the black band portion, re-inserts the caption in the portion of the main image where the content is displayed, i.e., in the portion that is not the black band. For example, the image following reduction is such that, with the image in FIG. 2, the vertical direction is 720 pixels and the horizontal direction is 958 pixels, 1332 pixels, or 1692 pixels.

Also, in further detail, the video output unit 26 performs trimming (i.e., cropping) to remove the edge portion region of the main image by a width of 5% to 15% of the entire size of the main image, for example, corresponding to the amount of over scanning. For example, in the event that the main image is an SDTV image, and there is no enlargement nor reduction, just trimming of the main image is performed, and in the event that the main image is 1080p and a black band is included in the main image, the black band image is removed from the main image, and further trimming is performed, following which the main image is reduced.

Upon performing enlargement and reduction (i.e., resizing) of the main image as appropriate, the video output unit 26 supplies the main image to the I/P converting unit 27 and also supplies the background image to the background image processing unit 30. Note that a background image which matches the size of the main image following the trimming, enlargement, or reduction as appropriate, is read out from the recording unit 25.

In step S43, the I/P converting unit 27 performs I/P conversion of the main image supplied from the video output unit 26 as appropriate, and converts the main image into a progressive format image.

Also, the I/P converting unit 27 performs frame rate conversion on the main image as appropriate, so that the frame rate of the main image is 24 Hz. Converting the frame rate of the main image from 60 Hz to 24 Hz which is often used in movies, for example, allows the user viewing the main image to experience a sense of presence as if he/she were in a theater.

Upon performing I/P conversion and frame conversion, the I/P converting unit 27 supplies the main image obtained as the result thereof to the main image processing unit 28.

In step S44, the main image processing unit 28 performs image processing on the main image supplied from the I/P converting unit 27. For example, the main image processing unit 28 subjects the main image to image processing so that the image quality of the main image improves, and so that the main image looks like a movie.

Specifically, the main image processing unit 28 reduces the luminance value of the main image such that the luminance of the overall main image is lowered by 10% or more, and reduces the light around the edge of the main image such that the luminance value of around the edges of the main image is lower than the luminance value of the middle of the main image. At this time, around the edges of the main image, luminance adjustment is performed so that the luminance is lower for regions closer to the edges of the main image.

For example, if the background image is a dark image, the brightness of the main image at the time of viewing the main image will appear conspicuous and be sensed to be too bright, so suppressing the luminance of the overall main image allows the main image to be viewed with more ease. Also, suppressing the luminance of the overall main image allows shuddering and noise to be made less conspicuous even if the frame rate of the main image is 24 Hz.

Note that the luminance of the overall main image is adjusted in accordance with the luminance of the background image. The luminance of the background image is adjusted such that, for example, while the main image is being played, lights provided to the ceiling of the theater in the background image are dimmed, and while the main image is being stopped, lights on the ceiling of the theater are turned up. That is to say, the luminance of the overall image is adjusted such that the luminance of the background image is lower while playing the main image than while stopping playing of the main image.

In such a case, raising the luminance of the overall main image while stopping playing of the main image to simulate a situation of lights shining on the screen, and lowering the overall luminance of the main image while playing the main image, allows the user to experience a sense of presence as if he/she were viewing the main image in a theater.

Also, for example, the main image processing unit 28 adds by image processing to the main image effects occurring due to properties of a movie projector (i.e., film effects), such as horizontal shaking of the image, blurring near the edges of the image, gray noise, film scratches, film indexes at the start of a movie film, and so forth. By adding such gray noise and film scratches, the main image can be made to look more like a movie. Further, the main image can be made to look more like a movie by inserting superimposed material in the main image, and adding blurring and noise to captions on the main image, by image processing.

Further, the main image processing unit 28 may perform correction of, for example, contrast, brightness, sharpness, color saturation, and so forth of the main image by image processing, perform noise reduction, or the like. Particularly, the main image is displayed on the display unit 33 is a small size such as SDTV or the like, so even if the color of the main image is made to be deeper or edges are enhanced by adjusting sharpness, color bleeding and noise do not become conspicuous that readily, and better image quality improvement effects can be obtained. Thus, a main image with higher resolution can be displayed.

Note that the image processing performed on the main image such as contrast, brightness, sharpness, and so forth, may be different processing depending on the display mode that is selected. For example, in the event that the theater background mode has been selected as the display mode, settings can be made beforehand such as lowering the luminance and color temperature of the overall main image, so that correction suitable for each display mode is performed, and accordingly a main image can be presented with higher image quality.

Further, the main image processing unit 28 performs disparity adjustment of the main image as appropriate. For example, the main image processing unit 28 localizes the main image at the same depth position as the screen SC11 by adjusting the display position of the main image, so that the main images for the left eye and for the right eye are displayed at the same positions on the screens SC11 of the background image for the left eye and for the right eye.

Generally, in the event of performing stereoscopic display of the main image on the display unit 33, it would be unnatural if the main image were localized closer to the user as compared to the screen SC11 in the theater, and the user would not be able to have the sensation of watching a movie. Also, while it would not be unnatural for the main image to be localized deeper than the screen SC11, the eyes of the user would tire if there are many objects in the stereoscopic image with different localization positions.

Accordingly, the main image processing unit 28 sets the display position of the main image such that the main image is localized at the same position as the screen SC11 of the background image, giving a sense of unity between the main image and background image, so as to appear more natural. Also, in the event that text information such as captions is included in the black band portion of the main image, the text information is re-inserted into the main image, so the text information is also localized at the same position as the screen SC11, and accordingly does not appear unnatural. Also notice that disparity adjustment of the main image may be performed so that the main image is localized deeper than the screen SC11 of the background image as viewed from the user.

Upon image processing being performed by the main image processing unit 28 as to the main image, the main image processing unit 28 supplies the main image subjected to image processing to the geometric deforming unit 29, and the processing advances from step S44 to step S45.

In step S45, the geometric deforming unit 29 performs geometric deformation of the main image supplied from the main image processing unit 28, and supplies this to the output switching unit 31.

For example, in the event of projecting an image such as a movie on a screen at a theater, optical distortion occurs in the image displayed on the screen, due to properties of the lens of the projector. Accordingly, the geometric deforming unit 29 adds certain optical distortion to the main image, such as barrel-shaped, spool-shaped, trapezoidal, or the like, by performing geometric conversion of the main image. Thus, the main image can be made to appear more like a movie.

In step S46, the background image processing unit 30 performs image processing on the background image supplied from the video output unit 26, and supplies to the output switching unit 31.

Specifically, the background image processing unit 30 adjusts the luminance value of the background image such that the luminance value of the overall background image is lower than a predetermined value if during playing of the main image, and adjusts the luminance value of the background image such that the luminance value of the overall background image is higher than a predetermined value if stopping playing of the main image. Accordingly, effects can be expressed such as the theater lights in the background image being turned off and becoming dark while playing the main image, and the theater lights being turned on and becoming bright while not playing the main image, thereby increase the sense of presence.

In this way, providing virtual illumination devices in the background image and performing luminance adjustment of the background image and main image in the state of playing the main image, such as while playing or stopped, so as to express the virtual illumination devices being turned on and off, allows the following effects to be obtained. That is to say, upon the user instructing a main image to be played, the image processing device 11 sounds a buzzer announcing the start of a show. In this state, the background image is displayed on the display unit 33, but the lights in the theater in the background image are on, and the background image is bright overall. Also, the screen is white and the main image is not displayed.

From this state, the lights of the theater in the background image are gradually dimmed, inside the theater gradually becomes dark, and eventually the seats and the like can be barely seen. At this time, a black frame is displayed on the screen of the theater, the frame gradually becomes brighter, and the main image is displayed. Subsequently, the main image is played on the screen.

Further, in the event that pausing or stopping of playing of the main image is instructed by user operations as to the image processing device 11, the lights turn on in the theater in the background image, and the overall background image becomes brighter. If playing of the main image is restarted, the theater becomes dark again.

Thus, by performing luminance control of the background image and overall main image in accordance with playing operations of the main image, theater-like effects at the time of playing the main image can be further improved.

Upon image processing as to the background image being performed by the background image processing unit 30 and the background image being supplied to the output switching unit 31, the processing advances from step S46 to step S47.

In step S47, the output switching unit 31 switches the data of pixels of the image to be displayed on the display unit 33 which is to be output in increments of pixels. That is to say, the output switching unit 31 supplies one of the background image for the left eye from the background image processing unit 30-1, the background image for the right eye from the background image processing unit 30-2, the main image for the left eye from the geometric deforming unit 29-1, or the main image for the right eye from the geometric deforming unit 29-2, to the converting unit 32, in increments of pixels.

In step S48, the converting unit 32 converts (i.e., reformats) the color system of the image supplied from the output switching unit 31, i.e., the image where the main image and background image have been composited, and supplies to the display unit 33. Accordingly, an image for the left eye where the where the main image and background image have been composited is supplied from the converting unit 32-1 to the display unit 33, and an image for the right eye where the where the main image and background image have been composited is supplied from the converting unit 32-2 to the display unit 33.

Then in step S49, the display unit 33 performs stereoscopic display of the image of the content made up of the main image and background image supplied from the converting unit 32, and the content playing processing ends. For example, in the event that the display mode is the theater background mode, stereoscopic display of the image shown in FIG. 2 is performed on the display unit 33.

Note that in the event that the main image is a moving image, theater-like effects may be applied to the audio accompanying the main image.

Specifically, for example, an unshown audio playing unit generates 5.1-channel audio from the positional relation of the channels based on 2-channel audio and outputs this, thereby expressing reflected sound from the back of the theater, the audio is subjected to filtering processing to extend reverberation of the audio, and so forth. Thus, theater-like effects at the time of playing the main image can be further improved.

Also, effects such as reverberations and surround that are applied to the audio accompanying the main image, adjustment of volume, and so forth, may also be changed in accordance with the display mode.

Also, in the event that determination is made in step S41 that the display mode is not the theater background mode, i.e., in the event that the display mode is the enlarged size mode, the video output unit 26 reads out the specified main image form the recording unit 25 and supplies this to the I/P converting unit 27, and the processing advances to step S50.

In step S50, the I/P converting unit 27 performs I/P conversion on the main image supplied from the video output unit 26 to convert the main image to a progressive format image, and supplies this to the main image processing unit 28.

In step S51, the main image processing unit 28 performs image processing on the main image supplied from the I/P converting unit 27. For example, the main image processing unit 28 performs correction of the contrast, brightness, sharpness, color saturation, and so forth of the main image by image processing according to correction values set beforehand for the enlarged size mode, performs noise reduction, and so forth.

In step S52, the main image processing unit 28 performs enlarging processing on the main image as appropriate. For example, the main image is enlarged in the vertical direction and horizontal direction so that the number of pixels of the main image in the vertical direction is the same as the number of pixels of the display screen of the display unit 33 in the vertical direction. The main image processing unit 28 supplies the main image that has been enlarged as appropriate to the output switching unit 31 via the geometric deforming unit 29.

In step S53, the output switching unit 31 switches the data of pixels of the image to be displayed on the display unit 33 which is to be output in increments of pixels. That is to say, the output switching unit 31 supplies one of the main image from the geometric deforming unit 29-1 or the main image from the geometric deforming unit 29-2 to the converting unit 32. In step S53, upon the main image being output while switching the output in increments of pixels, the processing of step S48 and step S49 is subsequently performed and the content playing processing ends.

Thus, in the event that the theater background mode is selected, the image processing device 11 composites the main image and background image and displays. By pasting the main image in as part of a subject in the background image and displaying the main image and background image, the main image can be displayed more effectively with no deterioration in image quality, even in the event that the main image is smaller than the size of the display screen of the display unit 33.

That is to say, the user can be mentally made to feel that he/she is viewing a large screen by displaying the main image in the position of a screen of a theater in a background image, and displaying objects with which the user is familiar near the screen so as to make the user sense that the main image is at a distant position.

In particular, stereoscopic display of the image made up of the main image and background image is effective in causing the user to sense that the main image is at a distant position. Also, stereoscopic display of the background image allows the main image to be shown in a 3-D-like manner, even if the main image for the left eye and for the right eye is an image with no disparity.

Further, with the image processing device 11, the main image does not have to be enlarged to a larger size, so high-resolution main images can be displayed. This presentation method of images by the image processing device 11 can also be suitably applied to presenting of Internet contents, and horizontally-long Cinemascope contents and panorama contents.

Also, using an image with high resolution for the background image enables the image made up of the main image and background image to be sensed as being a high-class and high resolution image overall, and the main image can be presented even more effectively. Further, in the event that the main image is an SDTV or 720p image, trimming of the main image and compositing with the background image is sufficient, so the main image can be displayed effectively with even easier processing.

Note that an arrangement may be made wherein the background image is not displayed with stereoscopic display even in the event of performing stereoscopic display of the main image using main images for the left eye and for the right eye. In such a case, just one of the background images for the left eye and for the right eye, for example, is displayed on the display unit 33.

Also, the present disclosure is not restricted to processing with a playing system, and may also be applied to processing with a recording system. That is to say, an image obtained by compositing the main image and background image may be recorded in the recording unit 25.

### Second Embodiment

### Configuration of Image Processing Device

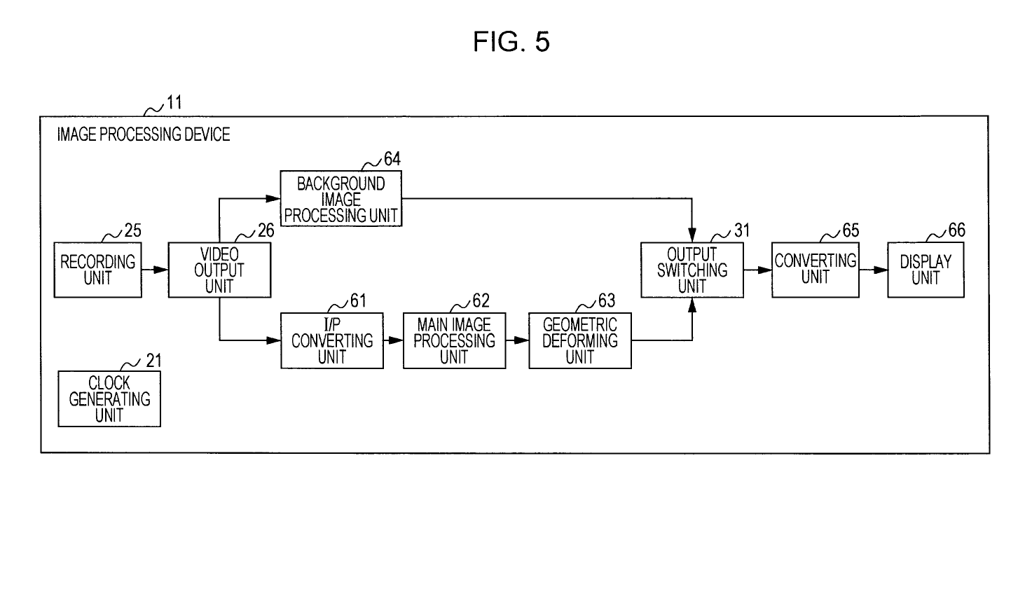

Also, while description has been made above that at least one of the main image and background image are subjected to stereoscopic display, both the main image and background image may 2-D images. In such a case, the image processing device 11 is configured as shown in FIG. 5.

That is to say, the image processing device 11 shown in FIG. 5 is configured of a clock generating unit 21, a recording unit 25, a video output unit 26, an I/P converting unit 61, a main image processing unit 62, a geometric deforming unit 63, a background image processing unit 64, a an output switching unit 31, a converting unit 65, and a display unit 66. In FIG. 5, parts the same as with the case of FIG. 1 are denoted with the same reference numerals, and description thereof will be omitted as appropriate.

The recording unit 25 has recorded multiple 2-D main images and background images that have been externally obtained, and supplies main images and background images to the video output unit 26 in accordance with user instructions. Also, the I/P converting unit 61, main image processing unit 62, geometric deforming unit 63, background image processing unit 64, and converting unit 65 perform processing the same as with the I/P converting unit 27, main image processing unit 28, geometric deforming unit 29, background image processing unit 30, and converting unit 32 in FIG. 1. The display unit 66 displays 2-D images supplied from the converting unit 65.

### Description of Content Playing Processing

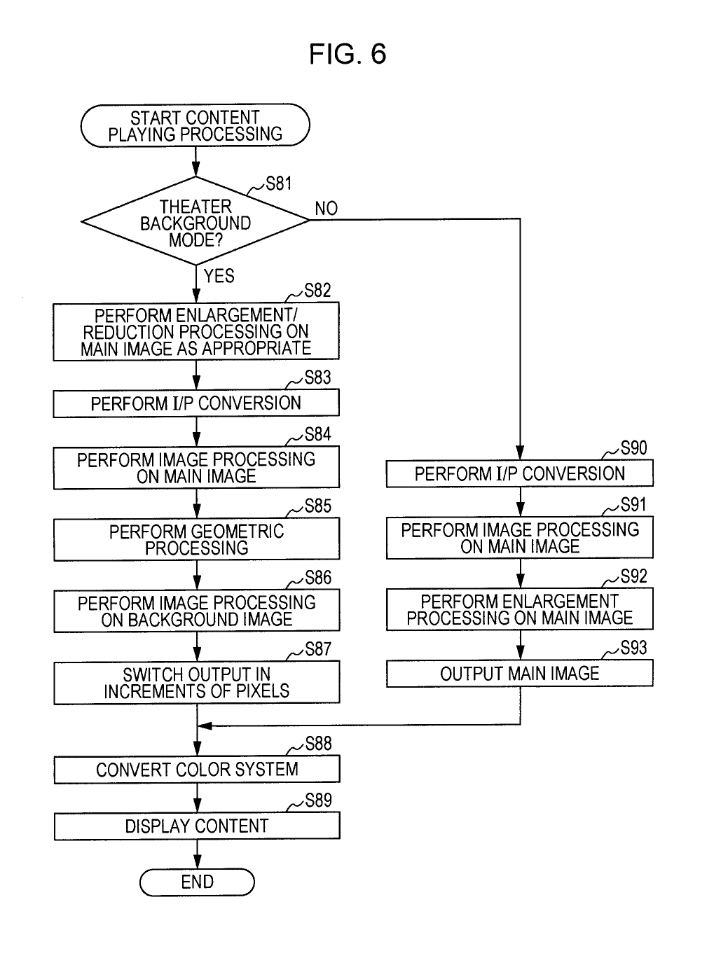

Next, content playing processing performed by the image processing device 11 in FIG. 5 will be described with reference to the flowchart in FIG. 6.

In step S81, the video output unit 26 determines whether or not the theater background mode is selected as the display mode.

In the event that determination is made in step S81 that the theater background mode is selected, the video output unit 26 reads out the specified 2-D main image and background image from the recording unit 25. Subsequently, the processing of step S82 through step S88 is performed, but this processing is the same as the processing of step S42 through step S48 in FIG. 4, so description thereof will be omitted.

Note however, that with step S42 through step S48, processing is performed on main images and background images for the left eye and for the right eye, but with step S82 through step S88, processing is performed on 2-D main image and background image.

Upon the processing of step S88 being performed and an image subjected to color system conversion, i.e., an image of which the main image and background image have been composited, being supplied from the converting unit 65 to the display unit 66, the processing of step S89 is performed.

That is, in step S89, the display unit 66 displays an image of content made up of the main image and background image supplied from the converting unit 65, and the content playing processing ends.

On the other hand, in the event that determination is made in step S81 that the mode is not the theater background mode, i.e., that the mode is the enlarged size mode, the video output unit 26 reads out the specified main image from the recording unit 25 and supplies this to the I/P converting unit 61. Subsequently, the processing of step S90 through step S92 is performed, but this processing is the same as the processing of step S50 through step S52 in FIG. 4, so description thereof will be omitted.

In step S93, the output switching unit 31 outputs the main image supplied from the geometric deforming unit 63 to the converting unit 65. Thereafter, the processing of step S88 and step S89 is performed, the main image is displayed on the display unit 66, and the content playing processing ends.

Thus, in the event that the theater background mode has been selected, the image processing device 11 composites the main image and background image and displays. By pasting the main image in as part of a subject in the background image and displaying the main image and background image, the main image can be displayed more effectively with no deterioration in image quality, even in the event that the main image is smaller than the size of the display screen of the display unit 66.

### Third Embodiment

### Configuration of External View of Image Processing Device

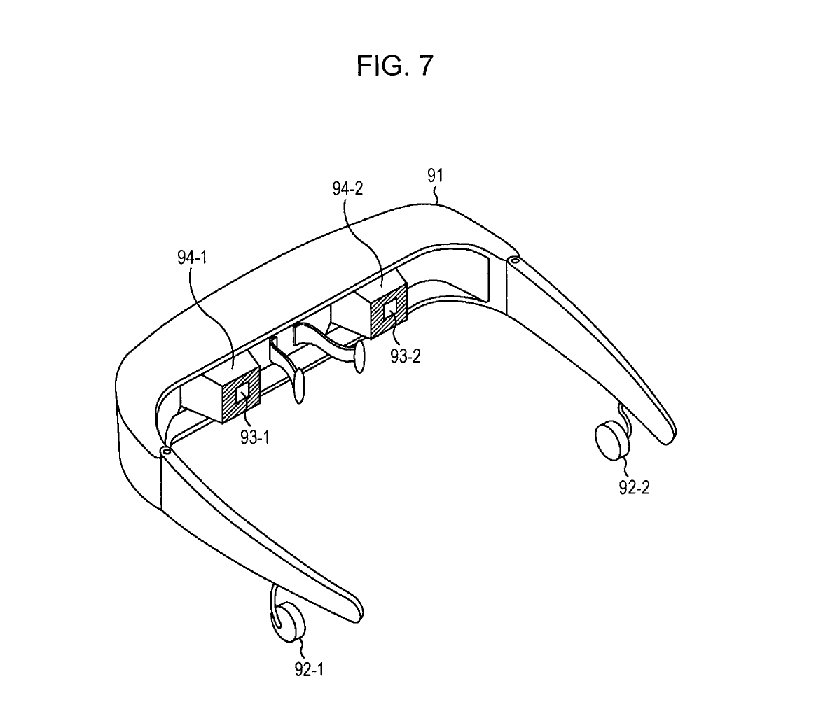

Also, the above-described main image can also be effectively displayed by using an image processing device 91 shown in FIG. 7, for example.

The image processing device 91 shown in FIG. 7 is an eyeglasses-type head mounted display to be mounted on the face (head) of the user, with an earphone 92-1 and earphone 92-2 provided to the temple arms to play audio accompanying the main image serving as the content. These earphone 92-1 and earphone 92-2 are mounted to the ears of the user.

Also, a display unit 93-1 for displaying the main image for the left eye and a display unit 93-2 for displaying the main image for the right eye are provided to the portions of the image processing device 91 corresponding to where lenses are provided to eyeglasses. That is to say, the display unit 93-1 and display unit 93-2 are provided to the image processing device 91 so as to be held by a holding unit 94-1 and holding unit 94-2 respectively, so as to be situated in front of the left and right eyes of the user when wearing.

Particularly, the surface portions of the holding unit 94-1 and holding unit 94-2 (the hatched portions in the drawing) surrounding the display screens of the display unit 93-1 and display unit 93-2 are arranged so as to be the same height thereas. The term height as used here means a position in a direction perpendicular to the display screen of the display unit 93-1 and display unit 93-2. That is to say, the display screen of the display unit 93-1 and display unit 93-2, and the surface portion of the holding unit 94-1 and holding unit 94-2, are arranged to be generally flush.

Note that hereinafter, in the event that the display unit 93-1 and display unit 93-2 do not have to be individually differentiated, these will also be referred to simply as display unit 93, and in the event that the holding unit 94-1 and holding unit 94-2 do not have to be individually differentiated, these will also be referred to simply as holding unit 94.

A background image such as shown in FIG. 2 for example is applied as a decal or the like to the surface portion of the holding unit 94. Specifically, a photograph decal or the like of the inside of a theater, with an opening provided to the screen portion thereof that is the same size as the display screen, is applied so that the portion corresponding to the main image P11 in FIG. 2 is the display screen of the display unit 93.

In further detail, the layout of the display screen of the display unit 93 and the surface portion of the holding unit 94 is arranged such that, when the user wears the image processing device 91, the screen of the inside of a theater in the photograph decal applied to the surface portion appears to the user to be at the far side as to the display screen.

Also, a display unit 93 with no outer frame provided out the perimeter of the display screen is used. In the event that there is an outer frame on the display screen, at the time of displaying the main image on the display unit 93 it will appear to the user viewing the main image as if there is a frame equivalent to approximately 1 m between the theater screen in the background image and the main image, thereby reducing the effects of the background image.

Further, the display screen of the display unit 93 and the surface portion of the holding unit 94, i.e., the background image added to the surface portion, as arranged so that the height in the depth direction are at the same height, as described above. Accordingly, this prevents a situation in which the user is not able to focus on the background image when the main image is displayed on the display unit 93, resulting in the background image appearing out of focus.

The background image added to the surface portion of the holding unit 94 is preferably detachable so as to be exchangeable with a desired one of multiple different background images. Also, a mechanism may be provided to the image processing device 91 so that external light does not enter the eyes of the user when the image processing device 91 is being worn by the user. For example, a member formed of black cloth may be attached to the image processing device 91 to shield external light.

### Configuration of Image Processing Device

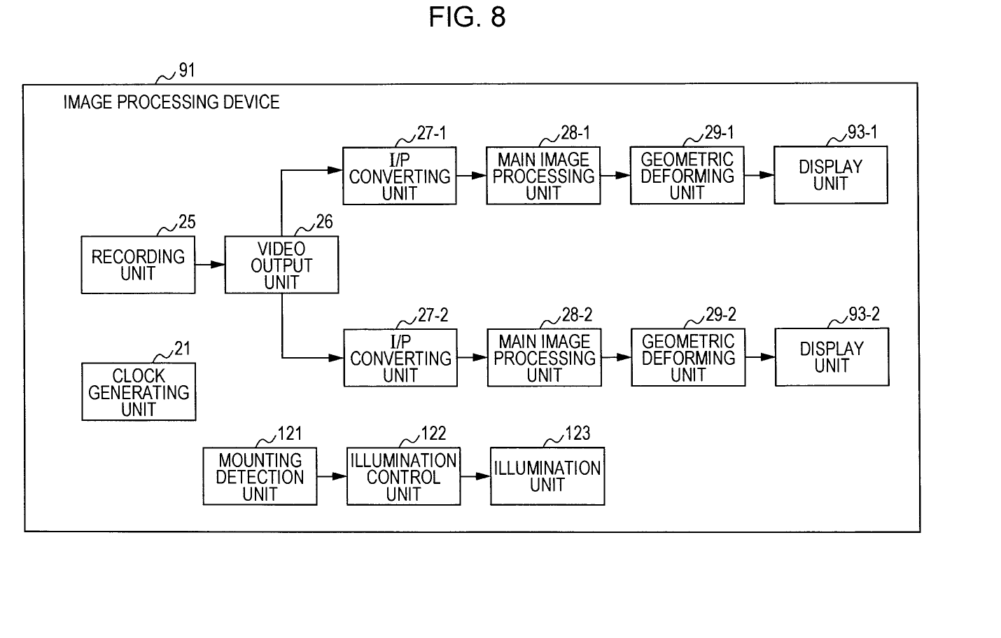

Next, a functional configuration of the image processing device 91 shown in FIG. 7 will be described. Fig. 8 is a block diagram illustrating a configuration example of the image processing device 91.

In the example in FIG. 8, the image processing device 91 is configured of a clock generating unit 21, a recording unit 25, a video output unit 26, a I/P converting unit 27-1, a I/P converting unit 27-2, a main image processing unit 28-1, a main image processing unit 28-2, a geometric deforming unit 29-1, a geometric deforming unit 29-2, a display unit 93-1, a display unit 93-2, a mounting detection unit 121, an illumination control unit 122, and an illumination unit 123.

In FIG. 8, parts that are the same as with the case of FIG. 1 or FIG. 7 are denoted with the same reference numerals, and description thereof will be omitted as appropriate.

With the image processing device 91, the main image read out from the recording unit 25 by the video output unit 26 is supplied to the display unit 93 via the I/P converting unit 27, main image processing unit 28, and geometric deforming unit 29, and the main image is displayed on the display unit 93.

Also, the mounting detection unit 121 is made up of a sensor or the like, to detect mounting of the image processing device 91 by the user, and supplies the detection results thereof to the illumination control unit 122. The illumination control unit 122 controls the illumination within the image processing device 91 by the illumination unit 123 in accordance with the mounting detection unit 121 and user operations. The illumination unit 123 is made up of a light source and so forth, and illuminates within the image processing device 91, i.e., around the eyes of the user and the display unit 93, under control of the illumination control unit 122.

### Description of Content Playing Processing

Now, when the user is not mounting the image processing device 91, the illumination unit 123 is in an off state. When the user mounts the image processing device 91 and the user mounting the image processing device 91 is detected by the mounting detection unit 121, the image processing device 91 performs content playing processing to play contents in accordance with user operations.

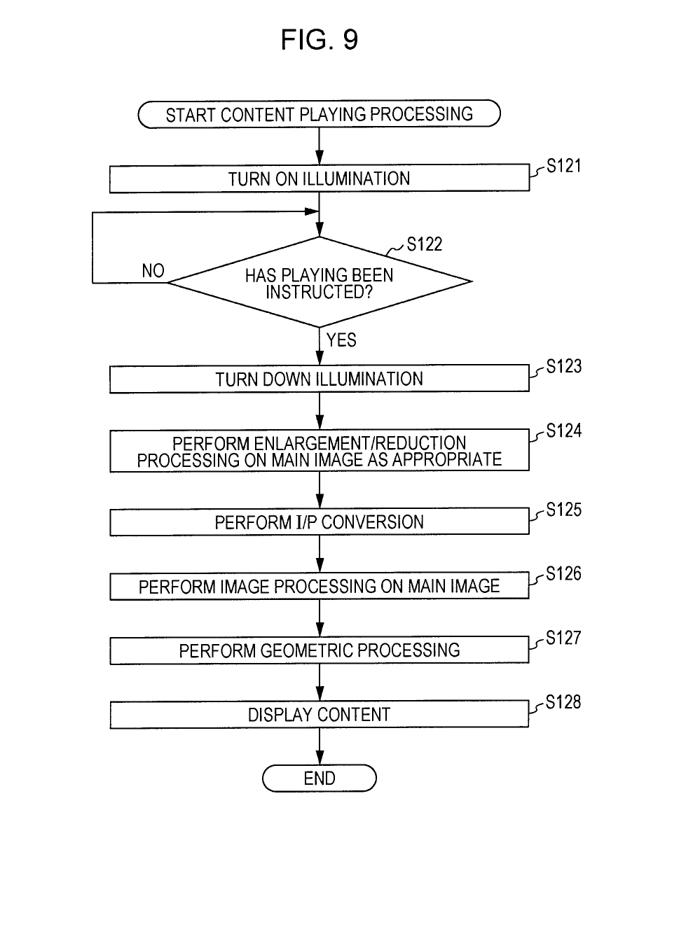

Hereinafter, content playing processing by the image processing device 91 will be described with reference to the flowchart in FIG. 9.

In step S121, the illumination control unit 122 turns the illumination unit 123 on based on detection results supplied from the mounting detection unit 121 to the effect that mounting by the user has been detected. Upon the illumination unit 123 illuminating within the image processing device 91 under control of the illumination control unit 122, the user wearing the image processing device 91 can see the background image added to the holding unit 94.

In step S122, the image processing device 91 determines whether or not the user has instructed playing of contents. For example, in the event that the user operates the image processing device 91 an instructs playing of a desired content (main image), determination is made that playing has been instructed.

In the event that determination is made in step S122 that playing has not been instructed, the processing returns to step S122 and the above-described processing is repeated until playing is instructed.

On the other hand, in the event that determination is made in step S122 that playing has been instructed, in step S123 the illumination control unit 122 controls the illumination unit 123 so as to darken the illumination within the image processing device 91. That is to say, the illumination unit 123 gradually dims the illumination under control of the illumination control unit 122. At this time, the illumination may be completely turned off, or may be left in a state with the illumination barely lit.

Also, upon the main image being specified and playing of the main image instructed, the video output unit 26 reads out the specified main image from the recording unit 25. Thereafter, the processing of step S124 through S127 is performed. That is to say, the main image for the left eye is supplied from the video output unit 26 to the display unit 93-1 via the I/P converting unit 27-1, main image processing unit 28-1, and geometric deforming unit 29-1. Also, the main image for the right eye is supplied from the video output unit 26 to the display unit 93-2 via the I/P converting unit 27-2, main image processing unit 28-2, and geometric deforming unit 29-2.

Note that the processing of step S124 through step S127 is the same as the processing of step S42 through step S45 in FIG. 4, so description thereof will be omitted.

In step S128, the display unit 93 performs stereoscopic display of the main image supplied from the geometric deforming unit 29, i.e., the image of the content, and the content playing processing ends.

Specifically, the display unit 93-1 displays the main image for the left eye, and the display unit 93-2 displays the main image for the right eye. Accordingly, the left eye and the right eye of the user observe the main images for the left eye and for the right eye respectively, and accordingly the main image is sensed stereoscopically.

Also, upon the user operating the image processing device 91 to instruct stopping of playing or pausing of the content, the image processing device 91 stops playing of the main image, and the illumination unit 123 turns on the illumination under control of the illumination control unit 122.

Thus, the image processing device 91 performs stereoscopic display of the main image in accordance with user operations.

Heretofore, head mounted displays have been designable such that an image equivalent to a visually large screen is displayed, but the user already knows that the display screen is small before wearing the head mounted display. Accordingly, it has been difficult with head mounted displays for the user to mentally feel the image being displayed as being large.

Conversely, with the image processing device 91, by applying a background image to the surface portions of the holding unit 94 surrounding the display screen of the display unit 93, the main image can be displayed as a part of the subject in the background image, and can enable the user to feel as if the contents were being enjoyed on a large screen. Thus, with the image processing device 91, the main image can be displayed more effectively without deterioration of image quality.

The above-described series of processing may be carried out by hardware or may be carried out by software. In the event of carrying out the series of processing by software, a program making up the software is installed from a program recording medium to a computer built into dedicated hardware, or a general-purpose personal computer for example, capable of executing various types of functions by various types of programs being installed thereto.

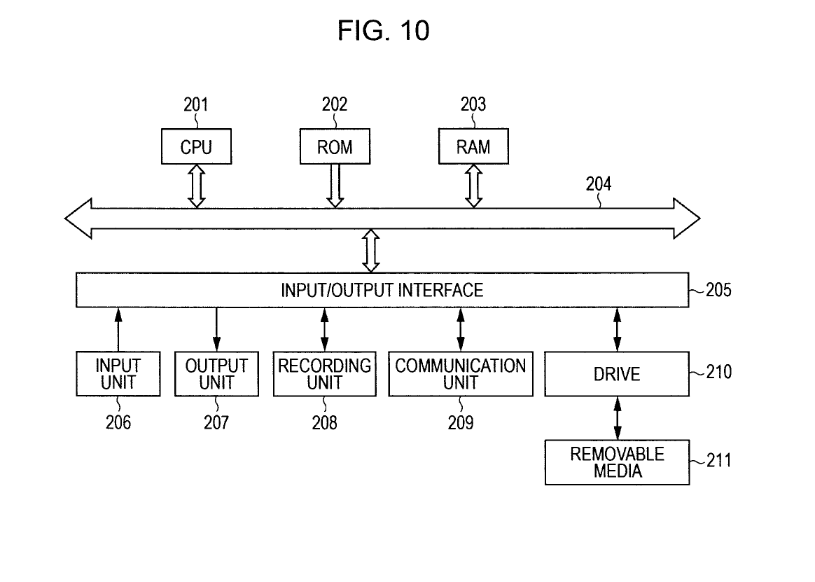

FIG. 10 is a block diagram illustrating a configuration example of hardware of a computer for executing the above-described series of processing according to a program.

With the computer, a CPU (Central Processing Unit) 201, ROM (Read Only Memory) 202, and RAM (Random Access Memory) 203, are mutually connected by a bus 204.

An input/output interface 205 is further connected to the bus 204. Connected to the input/output interface 205 are an input unit 206 made up of a keyboard, mouse, microphone, and so forth, and output unit 207 made up of a display, speaker, and so forth, a recording unit 208 made up of a hard disk, non-volatile memory, and so forth, a communication unit 209 made up of a network interface and the like, and a drive 210 for driving removable media 211 such as magnetic disks, optical discs, magneto-optical disks, semiconductor memory, and so forth.

With a computer configured as described above, the CPU 201 loads the program recorded in the recording unit 208, for example, to the RAM 203 via the input/output interface 205 and bus 204 and executes this, thereby performing the above-described series of processing.

The program which the computer (CPU 201) executes is recorded in removable media 211 (i.e., a non-transitory, computer-readable storage medium) made of such as, for example, magnetic disks (including flexible disks), optical disks (CD-ROM (Compact Disc-Read Only Memory), DVD (Digital Versatile Disc) and so forth), magneto-optical disks, semiconductor memory, and so forth, which are packaged media, and provided, or is provided via cable or wireless transfer media such as a local area network, the Internet, digital satellite broadcasting, and so forth.

The program can be installed to the recording unit 208 via the input/output interface 205, by the removable media 211 being mounted to the drive 210. Also, the program can be installed in the recording unit 208 by being received with the communication unit 209 via cable or wireless transfer media. As another arrangement, the program can be installed in the ROM 202 or recording unit 208 beforehand.

Note that the program which the computer executes may be a program regarding which processing is performed following the time sequence in the order described in the present Specification, or may be a program regarding which processing is performed in parallel, or at appropriate timing, such as being called up.

Note that the embodiments of the present disclosure are not restricted to the above-described embodiments, and that various modifications may be made without departing from the essence of the present disclosure.

It should be understood by those skilled in the art that various modifications, combinations, sub-combinations and alterations may occur depending on design requirements and other factors insofar as they are within the scope of the appended claims or the equivalents thereof.

What is claimed is:

1. A processing device for combining content data with background data, comprising:
a left-eye content data processing unit configured to:
receive left-eye content data representing a left-eye content display pattern; and
set a left-eye content display position of the left-eye content display pattern, based on a position of a left-eye virtual screen display pattern included in a left-eye background display pattern represented by left-eye background data;
a right-eye content data processing unit configured to:
receive right-eye content data representing a right-eye content display pattern; and
set a right-eye content display position of the right-eye content display pattern, based on a position of a right-eye virtual screen display pattern included in a right-eye background display pattern represented by right-eye background data; and
an output unit configured to:
combine the left-eye content data with the left-eye background data to create left-eye output data representing a left-eye output display pattern, based on the left-eye content display position; and
combine the right-eye content data with the right-eye background data to create right-eye output data representing a right-eye output display pattern, based on the right-eye content display position.

2. The processing device of claim 1, comprising an original content data processing unit configured to:
receive original content data representing an original content display pattern;
modify the original content data; and
output the original content data as the left-eye content data and the right-eye content data.

3. The processing device of claim 2, wherein the original content data processing unit is configured to modify the original content data to reposition a caption display pattern included in the original content display pattern.

4. The processing device of claim 2, wherein the original content data processing unit is configured to modify the original content data to remove a black band display pattern included in the original content display pattern.

5. The processing device of claim 2, wherein the original content data processing unit is configured to modify the original content data to crop the original content display pattern.

6. The processing device of claim 2, wherein the original content data processing unit is configured to modify the original content data to resize the original content display pattern.

7. The processing device of claim 2, wherein the original content display pattern includes a left-eye original content display pattern and a right-eye original content display pattern.

8. The processing device of claim 2, comprising a content data conversion unit configured to:
receive at least one of the left-eye content data or the right-eye content data;
reformat the at least one of the left-eye content data or the right-eye content data; and
output the at least one of the left-eye content data or the right-eye content data to at least one of the left-eye content data processing unit or the right-eye content data processing unit.

9. The processing device of claim 1, comprising a background data processing unit configured to:
receive at least one of the left-eye background data or the right-eye background data;
modify the at least one of the left-eye background data or the right-eye background data to adjust a luminance of at least one of the left-eye background display pattern or the right-eye background display pattern; and
output the at least one of the left-eye background data or the right-eye background data to the output unit.

10. The processing device of claim 1, wherein:
the left-eye content data processing unit is further configured to modify the left-eye content data to adjust a luminance of the left-eye content display pattern; and
the right-eye content data processing unit is further configured to modify the right-eye content data to adjust a luminance of the right-eye content display pattern.

11. The processing device of claim 1, wherein:
the left-eye content data processing unit is further configured to modify the left-eye content data to add a film-effect display pattern to the left-eye content display pattern; and
the right-eye content data processing unit is further configured to modify the right-eye content data to add a film-effect display pattern to the right-eye content display pattern.

12. The processing device of claim 1, wherein:
the left-eye content data processing unit is further configured to modify the left-eye content data to correct at least one of the contrast, brightness, sharpness, or color saturation of the left-eye content display pattern; and
the right-eye content data processing unit is further configured to modify the right-eye content data to correct at least one of the contrast, brightness, sharpness, or color saturation of the right-eye content display pattern.

13. The processing device of claim 1, comprising a content data deformation unit configured to:
receive at least one of the left-eye content data or the right-eye content data;
modify the at least one of the left-eye content data or the right-eye content data to deform at least one of the left-eye content display pattern or the right-eye content display pattern; and
output the at least one of the left-eye content data or the right-eye content data to the output unit.

14. The processing device of claim 1, comprising a display unit configured to display the left-eye and right-eye output display patterns.

15. The processing device of claim 14, comprising an output data conversion unit configured to:
receive at least one of the left-eye output data or the right-eye output data;
reformat the at least one of the left-eye output data or the right-eye output data; and
output the at least one of the left-eye output data or the right-eye output data to the display unit.

16. A method of combining content data with background data, comprising:
receiving left-eye content data representing a left-eye content display pattern;
setting a left-eye content display position of the left-eye content display pattern, based on a position of a left-eye virtual screen display pattern included in a left-eye background display pattern represented by left-eye background data;
receiving right-eye content data representing a right-eye content display pattern;
setting a right-eye content display position of the right-eye content display pattern, based on a position of a right-eye virtual screen display pattern included in a right-eye background display pattern represented by right-eye background data;
combining the left-eye content data with the left-eye background data to create left-eye output data representing a left-eye output display pattern, based on the left-eye content display position; and
combining the right-eye content data with the right-eye background data to create right-eye output data representing a right-eye output display pattern, based on the right-eye content display position.

17. A non-transitory, computer-readable storage medium storing a program that, when executed by a processor, causes a processing device to perform a method of combining content data with background data, the method comprising:
receiving left-eye content data representing a left-eye content display pattern;
setting a left-eye content display position of the left-eye content display pattern, based on a position of a left-eye virtual screen display pattern included in a left-eye background display pattern represented by left-eye background data;
receiving right-eye content data representing a right-eye content display pattern;
setting a right-eye content display position of the right-eye content display pattern, based on a position of a right-eye virtual screen display pattern included in a right-eye background display pattern represented by right-eye background data;
combining the left-eye content data with the left-eye background data to create left-eye output data representing a left-eye output display pattern, based on the left-eye content display position; and
combining the right-eye content data with the right-eye background data to create right-eye output data representing a right-eye output display pattern, based on the right-eye content display position.
